(19) United States
(12) Patent Application Publication
(10) Pub. No.: US 2009/0303157 A1
(43) Pub. Date: Dec. 10, 2009

(54) DISPLAY DEVICE

(76) Inventors: Akira Imai, Nara (JP); Tomoo Takatani, Nara (JP); Hiroshi Fukushima, Nara (JP); Koji Yabuta, Nara (JP); Yoshihide Koyama, Mie (JP)

Correspondence Address: NIXON & VANDERHYE, PC, 901 NORTH GLEBE ROAD, 11TH FLOOR, ARLINGTON, VA, 22203, US

(21) Appl. No.: 12/066,587

(22) PCT Filed: Jun. 16, 2006
(86) PCT No.: PCT/JP2006/312121

§ 371 Date: Aug. 10, 2009

(30) Foreign Application Priority Data
Sep. 16, 2005 (JP) 2005 271220

(51) Int. Cl. G09G 5/00

(52) U.S. Cl. 345/7

(57) ABSTRACT

A display device (1a) of the present invention includes a displaying section (10), an image generating section (2) for generating an image signal, and a parallax barrier aperture array (17), distinction means (3) for judging whether cross talk of an image of another-pixels reaches a level at which the cross talk is perceived by a viewer of an image of self-pixels, and adjustment means (4) for adjusting the pixel signals of the another-pixels so as to eliminate the cross talk, in a case that the distinction means (3) judges the cross talk of the image of the another-pixels reaches to the perceivable level. This provides a display device and a vehicle equipped therewith, both of which display, on a single display screen, different images in a plurality of display directions and thus are capable of providing excellent display environments wherein the viewer of an image displayed in one display direction does not perceive cross talk of an image displayed in another direction.

### TECHNICAL FIELD

The present invention relates to a display device that displays on a single display screen different images in a plurality of directions respectively, and more particularly to a display device that offers good display environments, in both of the display directions, where cross talk of an image displayed in one display direction is not perceived by a viewer watching an image displayed in another display direction.

### BACKGROUND ART

Recently, a display device capable of displaying different images in a plurality of directions on a single display screen (a DV (dual view) display) has been proposed.

FIG. 11 is a cross-sectional view schematically illustrating an example of such display device. A display device illustrated in FIG. 11 includes a display panel 110, a barrier section 120, a backlight 130, and polarizers 141, 142.

The backlight 130, as FIG. 11 illustrates, includes a light source 131 and a reflecting section 132, and is configured so as to reflect a light from the light source 131 by the reflection section 132, and thereby irradiate the display panel 110 with a light.

The display panel 110 is an active-matrix type liquid crystal display panel, in which a liquid crystal layer is sandwiched between a TFT substrate 111 and a CF substrate 112 aligned facing each other.

On the TFT substrate 111, a plurality of data signal lines and a plurality of scanning signal lines intersecting with the data signal lines are provided, and pixels are provided at each intersection therebetween (none of the above is illustrated). In addition, the data signal line and the scanning signal line are connected to a source driver and a gate driver, respectively (neither is illustrated). As a result, drive voltages are independently applied to the pixels, changing alignment conditions of liquid crystal molecules in pixel regions in the liquid crystal layer 113 so that an image is displayed.

With respect to the pixels, a pixel array L for image display to the left side (the image display to the left side of the display device) and a pixel array R for image display to the right side (image display to the right side of the display device) are, as FIG. 11 illustrates, alternately arranged along a direction where the data signal lines extend.

On the CF (color filter) substrate 112, a color filter layer (not illustrated) is provided.

Besides, on surfaces of the TFT substrate 111 and the CF substrate 112 which surfaces face each other, alignment films (not illustrated) subjected to alignment process in directions orthogonal to each other are respectively provided. Further, the polarizer 141 is disposed on the backlight 130 side of the TFT substrate 111 such that an absorption axis direction becomes parallel to the alignment processing direction of the alignment films provided on the TFT substrate 111. In addition, the polarizer 142 is disposed on the side opposite of the display screen side (the backlight 130) of the barrier section 120 such that the absorption axis direction of the polarizer 142 becomes orthogonal to that of the polarizer 141. This varies the drive voltages to be applied to the pixels, thus images are displayed in respective display directions in each pixel array.

The barrier section 120 includes a barrier glass 121, barrier light shielding layers 122, and a resin layer 123. The barrier light shielding layer 122 blocks a part of light emitted from the backlight 130 and passing through the display panel 110. The resin layer 123 is formed on the barrier glass 121 so that the barrier light shielding layers 122 are covered with the resin layer 123, and the resin layer 123 connects the barrier section 120 with the display panel 110.

Furthermore, the barrier light shielding layers 122 are arranged in striped lines so as to correspond to each pixel array. That is, lines of the barrier light shielding layer 122 are provided for blocking the part of the light emitted from the backlight 130 and passing through the pixel arrays, such that the pixel array L can be perceived from the left side of the display device yet not from the right side and the pixel array R can be perceived from the right side of the display device yet not from the left side. This allows the display device to display different images (DV display) respectively to the left side and the right side thereof.

As display devices having such display mode, devices disclosed in Patent Documents 1 to 3 are known.

Patent Document 1 discloses an information display device for vehicle use in which images for left and right viewpoints of a driver seat and images for left and right viewpoints of a front passenger seat are arranged alternately pixel by pixel so that stereo images can be watched from the driver seat and the front passenger seat.

Further, Patent Document 1 also discloses the configuration in which while a vehicle is being driven, blank images for the left and right viewpoints of the driver seat are shown in combination with images for the left and right viewpoints of the front passenger seat, so that the stereo image can be viewed solely from the front passenger seat yet not viewed from the driver seat.

Patent Document 1: Tokukai-hei 7-105484 (published on Apr. 21, 1995)

Patent Document 2: Tokukai 2000-137443 (published on May 16, 2000)

Patent Document 3: Tokukai 2005-78094 (published on Mar. 24, 2005)

### DISCLOSURE OF INVENTION

### Problems to be Solved by the Invention

With the display device disclosed in Patent Document 1, however, there may be a case that even if the image for the driver seat side is made blank, the image for the front passenger seat side is perceived from the driver seat side due to cross talk. In addition, in a case that an image is displayed for the front passenger seat side solely while no image is displayed (black image is displayed) for the driver seat side by using the conventional DV display device illustrated in FIG. 11, the same problem will arise.

That is, the display device described in Patent Document 1 and FIG. 11 make it possible to separate image light beams in respective display directions by using a parallax barrier system, which is an image dividing technique proposed conventionally. Nevertheless, cross talk, leakage of the image for the front passenger seat side to the driver seat side, is more likely to be obvious especially when a black image is displayed to the driver seat side while an image is displayed to the front passenger seat side by using the parallax barrier system; therefore, separation capability has to be improved.

A reason that the cross talk described above occurs is explained with reference to FIG. 12. FIG. 12 is a view illustrating an exemplary display condition where with use of the conventional DV display device of FIG. 11 as a display device for vehicle use, different images are displayed respectively to the driver seat side and the front passenger seat side.

As FIG. 12 illustrates, when different images are displayed respectively to the driver seat side (right side) and to the front passenger seat side (left side), of light beams 150R passing through the pixel arrays R for the right side, a light beam directing to the driver seat side is outputted thereto through a gap between the barrier light shielding layers 122 while a light beam directing to the front passenger seat side is blocked by the barrier light shielding layers 122 ((b) in FIG. 12). On the other hand, of light beams 150L passing through the pixel arrays L for the left side, a light beam directing to the front passenger seat side is outputted thereto through the gap between the barrier light shielding layers 122 while a light beam directing to the driver seat side is blocked by the barrier light shielding layers 122 ((b) in FIG. 12). Accordingly, it is possible, in principle, to separate images (image light beams) to be displayed respectively to the driver seat side and the front passenger seat side.

In practice, however, a scattered or diffracted light 160 is generated due to multiple reflections or the like between layers of the display device. Therefore, cross talk is generated as the scattered or diffracted light 160 is outputted in display directions, and the separation capability of the image is lowered. That is, by the parallax barrier system, it is, in principle, possible to separate image light beams for display direction; however, in practice, cross talk is generated due to the multiple reflections between the layers of the display.

Relatively, such cross talk is less likely to be perceived when images are displayed respectively to both the driver seat side and the front passenger seat side (when the black display is not presented to the driver seat side). On the other hand, when the black display is presented to the driver seat side, the cross talk is likely to be perceived since the image displayed to the front passenger seat side is vaguely reflected on the display to the driver seat side.

FIG. 13 is a view illustrating an exemplary case in which, with use of the DV display device illustrated in FIG. 11, the image is displayed to the front passenger seat side only while the black display is presented to the driver seat side.

As FIG. 13 illustrates, light beams 150R passing through pixel arrays R are blocked by the polarizer 142 in a case that no image is displayed (black image is displayed) to the driver seat side ((b) in FIG. 13). Therefore, normally, no image is supposed to be displayed to the driver seat side. In practice, however, the scattered or diffracted light 160 is outputted to the driver seat side ((b) in FIG. 13). Accordingly, there may be a case that the image displayed to the front passenger seat side is superimposed on the black image for the driver seat side, and such superimposed image is perceived ((a) in FIG. 13).

As described above, the DV display device for vehicle use is considered to involve scenes that a black image is displayed to the driver seat side (no image is displayed for the driver seat side) while an image is displayed solely to the front passenger seat side during the vehicle is being driving. However, with the conventional art, there are cases that an image displayed to the front passenger seat side is vaguely reflected on the black image for the driver seat side, and such superimposed images are perceived from the driver seat side due to the cross talk generated from the reason explained above.

In such cases, it is expected that the driver's attention may get distracted from driving especially if images of entertainment programs or the like displayed to the front passenger seat side are perceived (displayed to) by the driver seat side.

### Means for Solving the Problems

The present invention is achieved in the view of the aforementioned problem. An object of the present invention is to provide a display device and a vehicle equipped therewith, both of which display different images respectively in a plurality of display directions on a single display screen, and offer good display environments in both of the display directions by preventing cross talk of an image displayed in one display direction from being perceived by a viewer watching an image displayed in another display direction.

In order to attain the object, a display device according to the present invention is a display device which displays different images in a plurality of display directions respectively, including: displaying means in which a plurality of pixels for displaying images in predetermined directions are aligned in certain orders for the respective display directions of the images; an image generating section for generating image signals of the images displayed on the pixels; and light shield means for blocking light beams emitted from the pixels so that the light beams are not watched from any directions other than the display directions of the pixels, the display device including distinction means for judging whether cross talk of an image group b displayed in a direction other than a particular direction in which a viewer watches an image a displayed reaches a level at which the cross talk of the image group b is perceived by the viewer; and adjusting means for adjusting the image signals of the image group b to eliminate the cross talk, once the distinction means judges that the cross talk reaches the level at which the viewer perceives. Specifically, the display device of the present invention is preferably configured such that the image a is a first image displayed in a first direction and the image group b is a second image displayed in a second direction, different from the first direction.

According to the configuration above, in a case that the different images are displayed in a plurality of display directions, the display device of the present invention offers excellent display environments in the display directions, the excellent display environments where the viewer watching the image a (the first image displayed in the first direction) displayed in a particular display direction does not perceive the cross talk of the image group b (the second image displayed in the second direction) displayed in another display direction.

That is, the display device of the present invention includes: the distinction means for judging whether the cross talk of the second image reaches the level at which the cross talk of the second image is perceived by the viewer of the first image; and the adjustment means for adjusting the pixel signals of the second image so as to eliminate the cross talk once the distinction means judges that the cross talk reaches the level at which the cross talk is perceived by the viewer. Consequently, in a case that different images are displayed in a plurality of display directions respectively, particularly, even in a case that the first image and the second image have significantly different characteristics, the display device of the present invention can eliminate the cross talk by the distinction means judging whether the cross talk of the second image reaches the level at which the cross talk is perceived by the viewer of the first image, and the adjustment means adjusting the pixel signals of the second image according to the judgment result. As a result, according to the configuration above, it is possible to provide excellent display environments in the display directions, the excellent display environment where the cross talk of the images displayed in the display direction other than the particular display direction in which the viewer watches the image displayed is not perceived by the viewer.

According to the configuration above, when the display device of the present invention is used for a vehicle, the image displayed to the front passenger seat side (cross talk image) is not reflected vaguely on the black image displayed to the driver seat side even in a case that the image is displayed solely to the front passenger seat side while the black image is displayed to the driver seat side (no image is displayed to the driver seat side). Thus, even in a case, for example, that images of entertainment programs or the like are displayed to the front passenger seat side, those images are not perceived from the driver seat side: therefore, a situation in which the driver's attention is distracted from driving by the cross talk can be avoided.

Also, in addition to the configuration above, the display device of the present invention is preferably configured such that the distinction means includes: a luminance measuring section for measuring each luminance of the first image and the second image by digitalizing each image signal of the first image and the second image; and a judging section for judging that the cross talk reaches the level at which the cross talk is perceived by the viewer, in a case that luminance of the second image exceeds a predetermined luminance.

With this configuration, the display device of the present invention performs adjustment, in accordance with the luminance known to be influential over generation of the cross talk, such that the viewer of the first image does not perceive the cross talk; therefore, the display device can perform proper adjustment.

That is, the display device of the present invention is such that the luminance measurement section digitalizes the image signals of the first and second images, and measures the luminance thereof, and the judging section judges whether the luminance of the second image exceeds the predetermined luminance.

The “predetermined luminance” herein refers to a limit of luminance of the second image at which cross talk of the second image is not perceived by the viewer of the first image.

That is, since the judging section judges that “the cross talk is perceived” once the luminance of the second image exceeds the limit of luminance at which the viewer of the first image does not perceive the cross talk of the second image, the adjusting section can adjust the pixel signals of the second image so as to eliminate the cross talk, according to the decision result.

With this configuration, the display device of the present invention performs proper adjustment such that the viewer of the first image does not perceive the cross talk of the second image.

Also, in addition to the configuration above, the display device of the present invention is preferably configured such that the distinguishing means includes: a contrast measuring section for measuring each contrast of the first image and the second image by digitalizing each image signal of the first image and the second image; and a judging section for judging that the cross talk reaches the level at which the cross talk is perceived by the viewer, in a case that contrast of the second image exceeds a predetermined contrast.

With this configuration, in accordance with the contrast known to be influential over generation of the cross talk, the display device of the present invention performs the adjustment such that the cross talk of the second image does not occur to the first image; therefore, the display device of the present invention can perform proper adjustment.

That is, the display device of the present invention is such that the contrast measuring section digitalizes the pixel signals of the first and second images, and measures the contrasts thereof, and the judging section judges whether the contrast of the second image exceeds the predetermined contrast value.

The “predetermined contrast value” herein refers to a limit of a contrast of the second image at which limit the viewer of the first image does not perceive the cross talk of the second image.

That is, the judging section judges that “the cross talk is perceived” once the contrast of the second image exceeds the limit of the contrast; therefore, the adjustment means can adjust the pixel signals of the second image so as to eliminate the cross talk, in accordance with the judgment result by the judging section that “the cross talk is perceived.”

With this configuration, the display device of the present invention can perform proper adjustment such that the viewer of the first image does not perceive the cross talk of the second image.

Also, in addition to the configuration above, the display device of the present invention is preferably configured such that the distinguishing means includes: an information signal generating section for generating an external information signal in accordance with external information different from the pixel information; and a judging section for judging that the cross talk reaches the level at which the cross talk is perceived by the viewer, in accordance with the external information signals.

With this configuration, the display device of the present invention can perform proper adjustment so that the viewer of the first image does not perceive the cross talk of the second image.

That is, according to the configuration above, the distinction means includes: the information signal generating section generating external information signals in accordance with external information different from the image signals generated at the image generating section; and the judging section judging the cross talk in accordance with the external information signals.

Specifically, the display device of the present invention includes a clock time information outputting section capable of outputting clock time information, and uses the clock time information as the “external information.”

Also, as a configuration besides this, the “external information” may be viewing information of the viewer of the first image.

For example, if an environment under which the display device is viewed is nighttime, cross talk is more likely to be perceived, as compared to a case that the display device is viewed under a bright environment such as daytime. Therefore, the display device of the present invention generates by using the clock time information as the “external information,” and judges whether the cross talk is perceived, in accordance with that external information signals. That is, with this configuration, the display device can recognize that the display environment is of nighttime.

Also, for example, a vehicle often runs under a dark environment including a tunnel when the display device of the present invention is used for the vehicle. That is, with respect to the display device of the present invention, the cross talk becomes easily perceivable in such case, regardless of the time such as nighttime. Therefore, the display device of the present invention uses the viewing information of the viewer as the “external information.” Specifically, the display device is configured such that the viewer of the first image observes whether the cross talk of the second image is perceivable on the first image, and the information signal generating section generates the external information signals in accordance with that viewing information. Accordingly, even in the situation described above, the display device of the present invention can perform proper adjustment so that the cross talk is not perceived.

Also, in addition to the configuration above, the display device of the present invention is preferably configured such that the adjustment means is configured so as to lower luminance of the second image, in accordance with a judgment result by the judging section.

According to the configuration above, a display device in which the cross talk of the second image is not perceived by the viewer of the first image can be achieved by adjusting the luminance known to be influential over the generation of the cross talk.

Also, in addition to the configuration above, the display device of the present invention is preferably configured such that the adjustment means is configured so as to lower the contrast of the second image, in accordance with a judgment result by the judging section.

According to the configuration above, the display device where the cross talk of the second image does not occur to the first image can be achieved by adjusting the contrast known to be influential over generation of the cross talk.

Specifically, the adjustment means is preferably configured so as to lower the luminance of the second image to ¼ of the original luminance.

With this configuration, it is possible to surely avoid that the viewer of the first image perceives the cross talk of the second image.

Also, in addition to the configuration above, the display device of the present invention is preferably configured such that the adjustment means is configured so as to make pixels for displaying the second image display the first image, in accordance with a judgment result by the judging section.

With this configuration, the first image and the second image can be the identical images; therefore, it is possible to avoid the viewer from perceiving the cross talk.

Also, in addition to the configuration above, the display device of the present invention is preferably configured such that the adjustment means is configured so as to make the second image undisplayed, in accordance with a judgment result by the judging section.

According to the configuration above, the second image is made undisplayed if the judging section judges that the viewer of the first image perceives the cross talk of the second image. As a result, it is possible to avoid the viewer of the first image from perceiving the cross talk of the second image.

“Being undisplayed” herein refers to not displaying any images in effect by presenting a display with a single color such as black.

Particularly when the display device of the present invention is used for the vehicle and when the first image is arranged to be displayed to the driver seat side, the cross talk of the second image is not be perceived therefrom at all since the second image is undisplayed if it is judged that the cross talk of the second image is generated; therefore, it is possible to avoid the situation that the drivers attention gets distracted from driving.

### ADVANTAGEOUS EFFECT OF THE INVENTION

According to display device of the present invention, in a case that the different images are displayed in a plurality of display directions, the viewer watching the image a displayed in a particular display direction does not perceive the cross talk of the image group b displayed in another display direction: therefore, excellent display environments can be offered in each display direction.

For a fuller understanding of the nature and advantages of the invention, reference should be made to the ensuing detailed description taken in conjunction with the accompanying drawings.

### BRIEF DESCRIPTION OF DRAWINGS

FIG. 1 is a block diagram illustrating a configuration of a display device of First Embodiment of the present invention.

FIG. 2 is a cross sectional view illustrating a configuration of a display section provided in the display device of FIG. 1.

FIG. 3 is a cross sectional view illustrating a configuration of a color filter (CF) substrate of the display section of FIG. 2.

FIG. 4 is a flowchart explaining an operation of the display device of First Embodiment of the present invention.

FIG. 5 is a block diagram illustrating a configuration of a display device of Second Embodiment of the present invention.

FIG. 6 is a flowchart explaining an operation of the display device of Second Embodiment of the present invention.

FIG. 7 is a block diagram illustrating a configuration of a display device of Third Embodiment of the present invention.

FIG. 8 is a flowchart explaining an operation of the display device of Third Embodiment of the present invention.

FIG. 9 is a block diagram illustrating a configuration of a display device of Fourth Embodiment of the present invention.

FIG. 10 is a flowchart explaining an operation of the display device of Fourth Embodiment of the present invention.

FIG. 11 is a cross sectional view schematically illustrating an exemplary display device of the conventional art.

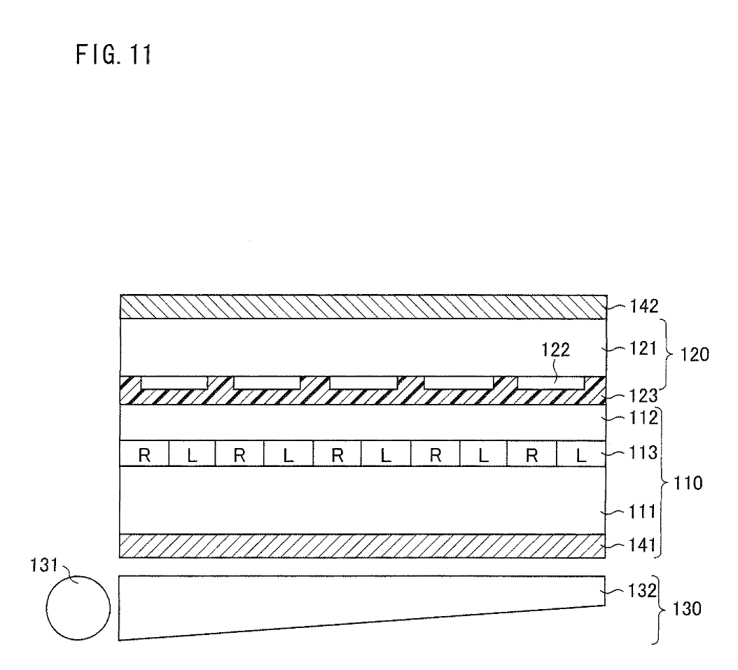

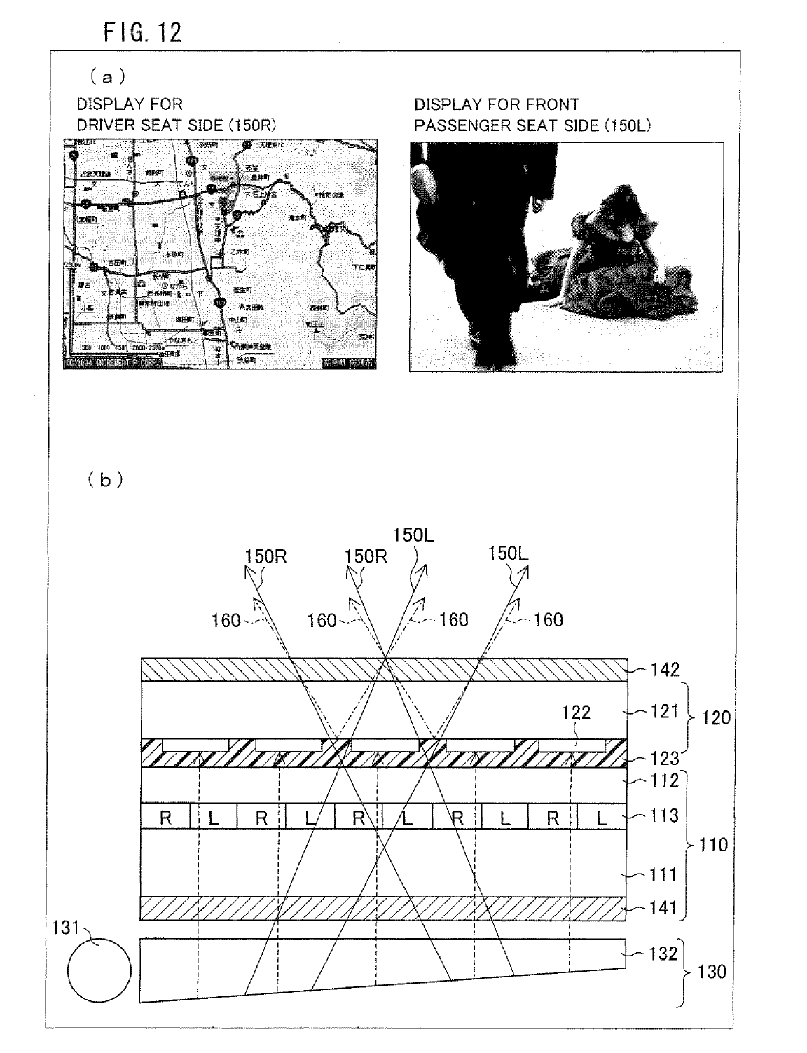

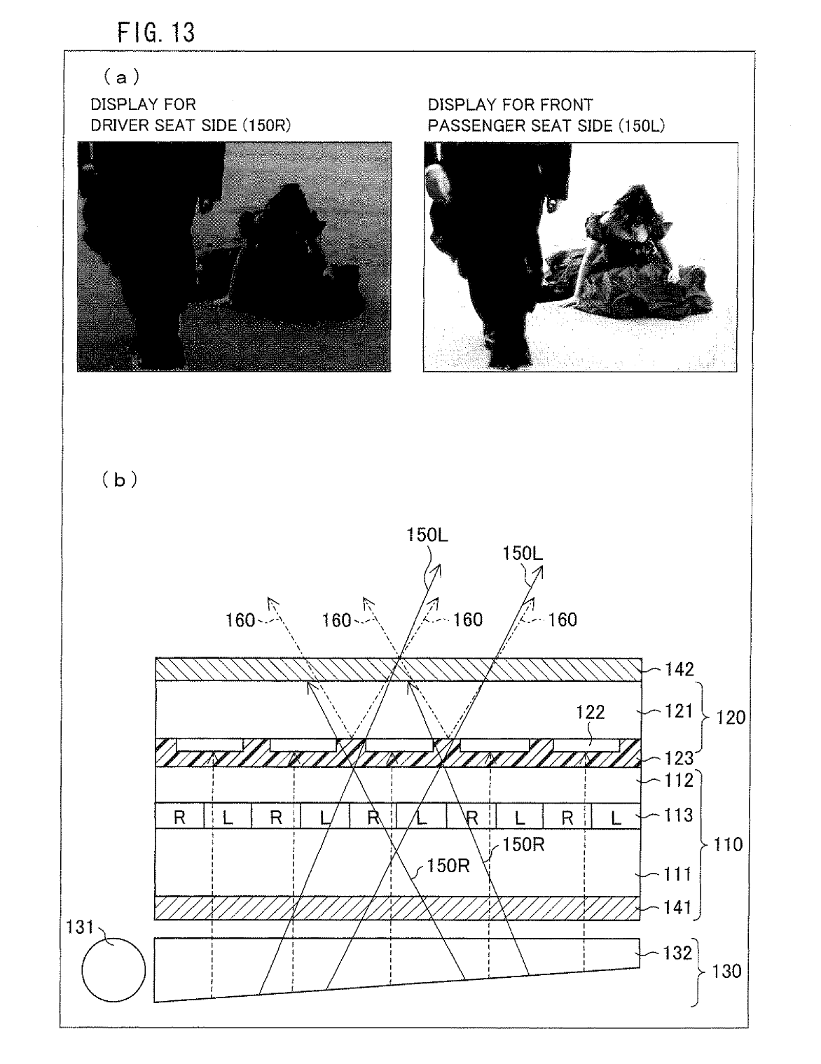

In FIG. 12, (a) is an explanatory view illustrating a cause of cross talk, and (b) is a cross sectional view schematically illustrating the display device of FIG. 11 in a case of (a).

In FIG. 13, (a) is an explanatory view illustrating, with use of the display device of FIG. 11, a condition in which the cross talk arises when a black image is displayed to a driver seat side while an image is displayed solely to a front passenger seat side, and (b) is a cross sectional view illustrating the display device of FIG. 11 in a case of (a).

### EXPLANATION OF REFERENCE NUMERALS

1a, 1b, 1c, and 1d Display device
2 Image generating section
3 Distinction means
3a Luminance measuring section
3a′ Contrast measuring section
3b and 3b′ Judging section
4 and 4′ Adjustment means
5 Distinction means
5a External information acquiring section (Information signal generating section)
5b Judging section
6 Input means (Information signal generating section)
8 Clock time information outputting section
10 Displaying section (display means and light shield means)
12 TFT substrate
13 CF substrate
14 Liquid crystal layer (display means)
15 Color filter
17 Parallax barrier aperture array (light shield means)

### BEST MODE FOR CARRYING OUT THE INVENTION

### Embodiment 1

One embodiment of the present invention will be described. It should be noted that the following description includes various sorts of technically preferable limitations to implement the present invention, yet the scope of the present invention is not limited to the specifics of the embodiments and drawings attached herewith.

Further, it should be noted that the following will describe a DV (dual view) display device for a vehicle use (hereafter a display device) that displays different images to a driver seat side and a front passenger (fellow passenger) side respectively, yet the present invention is not limited to the specifics of that embodiment. Therefore, the display device of the present invention can be applied to a display device for displaying a three-dimensional image (3D image). In addition, the display device of the present invention is limited to the dual view display device neither; rather it can be applied to a display device for displaying different images if viewed from three directions respectively. However, the display device of the present invention is most suitably applied to the DV display device for displaying different images on two pixels adjacent to each other.

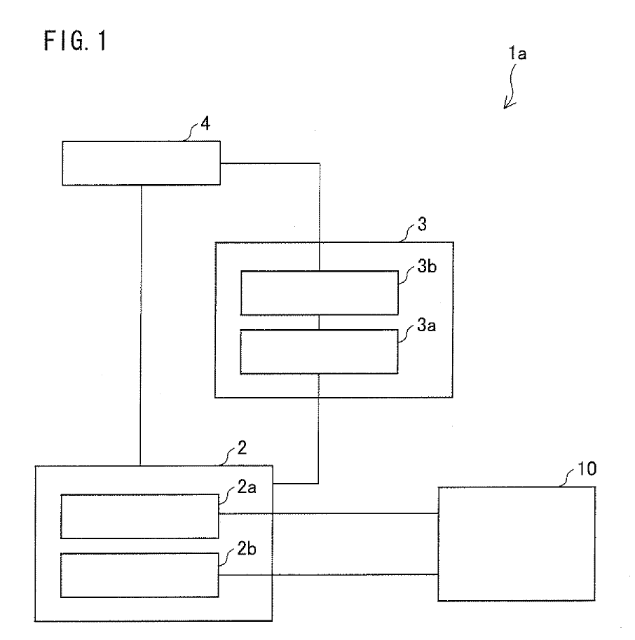

At first, the display device of the present invention will be described below with reference to FIGS. 1 to 4.

FIG. 1 is a block diagram illustrating a configuration of the display device of the present embodiment. A display device 1a illustrated in FIG. 1, for example, may be used as a display device that is used for a recently-common vehicle installed with a navigation function. Specifically, as described above, it may be used as the display device capable of displaying different images to the driver seat side and the front passenger (fellow passenger) seat side respectively. Thus, the display device 1a includes, as illustrated in FIG. 1, a display section 10 (display means and light shield means), an image generating section 2, distinction means 3, and adjustment means 4.

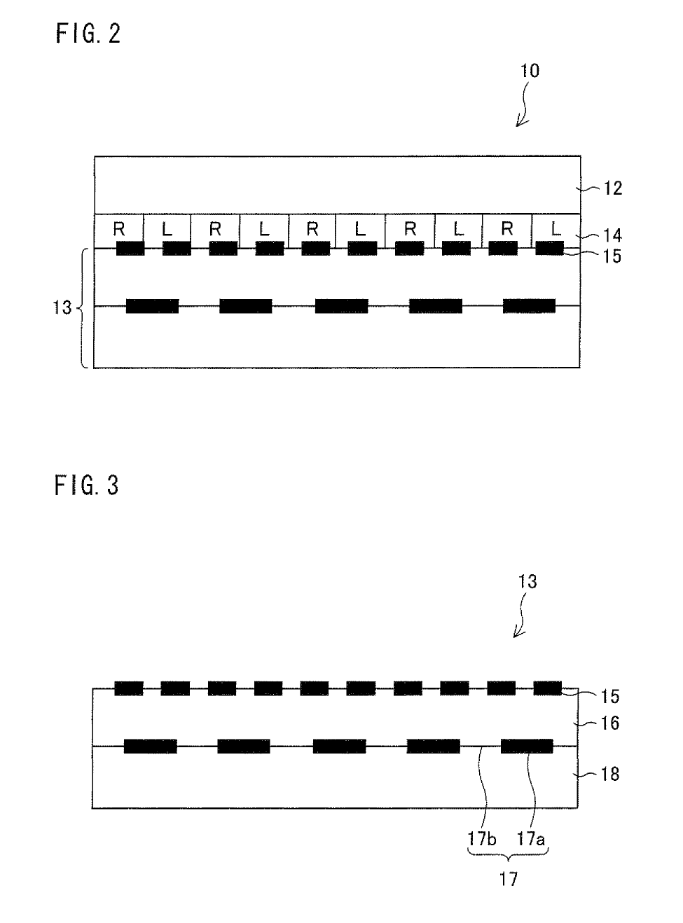

At first, a configuration of the display section 10 will be described with reference to FIG. 2. FIG. 2 is a cross sectional view illustrating the configuration of the display section 10. The display section 10, as illustrated in FIG. 2, includes a TFT substrate 12 and a CF (color filter) substrate 13, and a liquid crystal layer 14 (display means) composed of nematic liquid crystal and aligned therebetween.

The TFT substrate 12 can be formed of a transparent substrate. On the TFT substrate 12, a plurality of data signal lines and a plurality of scanning signal lines crossing the data signal lines are arranged, and pixels are provided for each intersection therebetween (neither is illustrated). Besides, the data signal lines and the scanning signal lines are respectively connected to a source driver and a gate driver constituting the image generating section 2 illustrated in FIG. 1.

Furthermore, on the TFT substrate 12, one of electrodes applying an electric field to each pixel (L and R in FIG. 2) is arranged, and the other electrode is arranged on the CF substrate 13 (neither is illustrated). The electrode arranged on the CF substrate 13 may also be shared by a plurality of pixels.

Also, on the surfaces of the TFT substrate 12 and the CF substrate 13 facing each other, alignment films aligned in directions substantially orthogonal to each other may be arranged respectively. Accordingly, it is configured such that drive voltages are respectively applied between electrodes corresponding to each pixel, and aligned states of liquid crystal molecules of each pixels region in the liquid crystal layer 14 is changed in order to display an image.

On the CF substrate 13, color filters 15 are arranged. The color filters are provided for each pixel. The CF substrate 13 can be thinned by a chemical etching treatment or by a chemical treatment including polishing.

A configuration of the CF substrate 13 will be described with reference to FIG. 3. FIG. 3 is a cross sectional view illustrating a configuration of the CF substrate 13. The CF substrate 13 includes a substrate 18, a parallax barrier aperture array 17 (light shield means), and a spacer layer 16.

The parallax barrier aperture array 17 is arranged on one of principle surfaces of the substrate 18. In the present embodiment, the parallax barrier aperture array 17 is formed by arranging opaque stripes 17a on a surface of the substrate 18 and defining transmissive slits 17b therebetween.

Specifically, the opaque stripes 17a of the parallax barrier aperture arrays 17 are arranged in a striped line parallel to a direction in which the pixel arrays R and L extend. Materials of the opaque stripe 17a are not particularly limited, and the opaque stripe 17a is formed, for example, of photosensitive resin with black pigment dispersed thereon.

Also, lines of the opaque stripes 17a are arranged to correspond to the pixel arrays of the liquid crystal layer 14. That is, lines of the opaque stripes 17a are arranged to block a part of light emitted from the pixel arrays of the liquid crystal layer 14 such that the light will not be perceived from any directions other than the display directions of the pixel arrays. Thus, pixel arrays R (image a) for the driver seat side are perceivable from the driver seat side, yet not from the front passenger seat side while pixel arrays L (image group b) are perceivable from the front passenger seat side, yet not from the driver seat side. Accordingly, the display device 1a can display different images respectively to the driver seat side (a first direction, a particular direction) and the front passenger seat side (a second direction, a direction different from the particular direction).

Positioning (alignment) of the parallax barrier aperture array 17 and the liquid crystal layer 14 has to be performed correctly so as to properly display images to the driver seat side and the front passenger seat side respectively. Therefore, the proper positioning is preferably performed by arranging alignment marks on the parallax barrier aperture array 17 and the liquid crystal layer 14, and aligning them according to the marks.

The spacer layer 16 may be formed of light transmitting resin, and is provided on the parallax barrier aperture array 17. The color filter 15 is arranged on the top surface of the spacer layer 16.

In the present embodiment, the parallax barrier aperture array 17 is away from the pixels of the liquid crystal layer 14 by the thickness of the spacer layer 16. The spacer layer 16 is illustrated as the single layer, yet there are cases, in fact, that more than two individual resin layers require to be stacked on top of each other so that the spacer layer having desired thickness is gained. For example, the spacer layer 16 may have the thickness of 50 μm and include polyethylene perephtalate. To form the spacer layer 16, the resin layers are stacked on top of each other by, for example, spin-coating or printing.

The spacer layer 16 is formed of the light transmitting resin in the present embodiment, yet the present invention is not limited to this configuration, and may also be formed of glass.

Also, the liquid crystal layer is used in the present embodiment, yet the present invention is not limited to this configuration either, and any transmissive image displaying layer may be used. Furthermore, the displaying layer may be a radiation displaying layer including a plasma display or an organic light emitting device (OLED) if the displaying section is used in “a front barrier mode,” with parallax optics being disposed between the image displaying layer and a viewer.

Next, configurations of the image generating section 2, the distinction means 3, and the adjustment means 4 of the display device 1a illustrated in FIG. 1 will be explained.

The image generating section 2 includes, as illustrated in FIG. 1, a source driver 2a and a gate driver 2b. As described above, the scanning signal lines are connected to the gate driver 2b and the data signal lines are connected to the source driver 2a. The gate driver 2b and the source driver 2a control voltage (image signal) to be applied to the scanning signal lines and the data signal lines, according to instructions from the adjustment means 4, which will be described later. Accordingly, the display panel 10 is configured such that desired images are displayed with respect to each display direction by changing the alignment states of the liquid crystal molecules corresponding to each pixel.

The distinction means 3 is provided so as to judge whether or not cross talk of an image displayed with respect to one display direction is perceived by a viewer of an image displayed to another display direction. The distinction means 3 is connected to the image generating section 2 and the adjustment means 4, receives the image signals provided to the scanning signal lines and the data signal lines from the image generating section 2, digitalizes the image signals, and judges whether or not the cross talk is generated by comparing the numeric values between pixels adjacent to each other. The judgment result is outputted to the adjustment means 4. Specific configuration of the distinction means 3 will be described later.

The adjustment means 4 is provided so as to adjust image signals (voltage) provided from the image generating section 2. Specifically, according to the judgment result by the distinction means 3, the adjustment means 4 adjusts the image signal so as to eliminate the cross talk in a case that the cross talk of the image displayed to one display direction is perceived by the viewer of the image displayed to another display direction. The adjustment means 4 does not perform any adjustment to the image generating section 2 in a case that it receives the judgment result that the cross talk is not perceived. Specific configuration of the adjustment means 4 will be described later.

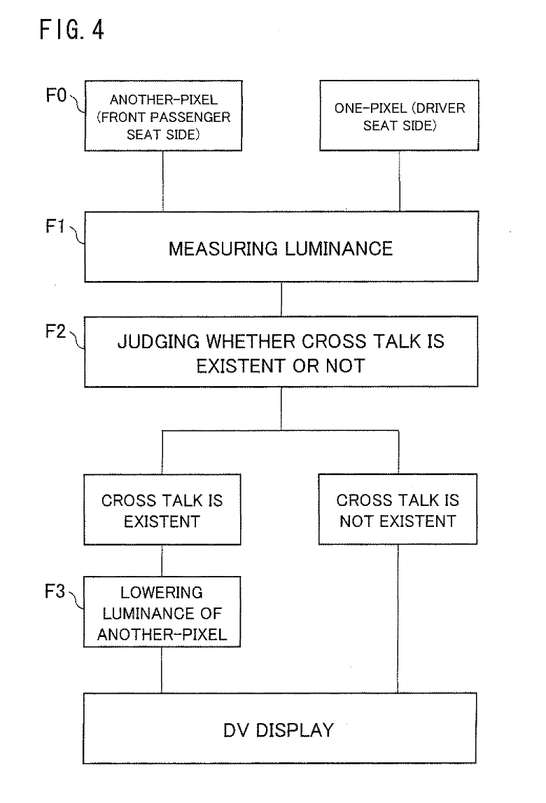

With reference to FIG. 4, operation of the display device 1a having the configuration above will be described next.

FIG. 4 is a flowchart describing the operation of the display device 1a. At first, the image signals are provided from the image generating section 2 to the scanning signal lines and the data signal lines of the liquid crystal layer 14 of the displaying section 10, and images are displayed on the pixels of the liquid crystal layer 14 (F0 in FIG. 4). The following description assumes that, of two pixels adjacent to each other (R and L in FIG. 2) in liquid crystal layer 14, a pixel displaying image to the driver seat side is a self-pixel (a first pixel) while a pixel adjacent to the self-pixel and displaying image to the front passenger seat side is an another-pixel (a second pixel).

The distinction means 3 acquires image signals of the self-pixels and the another-pixels substantially simultaneously as the image signals are provided from the image generating section 2, and judges whether or not the cross talk of the image of the another-pixels is perceived by the viewer (a person sitting on the driver seat side) of the image of the self-pixels.

Specifically, the distinction means 3 includes a luminance measuring section 3a measuring each luminance of the self-pixel and the another-pixels and a judging section 3b comparing the luminance thereof and judging (distinguishing) whether or not the cross talk of the image of the another-pixels is perceived by the viewer watching the image of the self-pixels. Luminance is a cause of the cross talk. Thus, the distinction means 3 can judge whether or not the cross talk of the image of the another-pixels is perceived by the viewer of the image of the self-pixels by comparing, in the judging section 3b, luminance of the self-pixels with that of the another-pixels.

At first, the luminance measuring section 3a acquires the image signals provided from the image generating section 2, and then digitalizes them so as to compute luminance of the self-pixels and the another-pixels (F1 in FIG. 4). Digitalizing is performed through, for example, setting up a threshold (for example, 128) to a digital value of the pixel luminance (0 to 255), and judging whether or not there is any digital value greater than or equal to the threshold. Subsequently, the judging section 3b compares each luminance of the self-pixels with that of the another-pixels, and judges whether or not the cross talk of the image of the another-pixels is perceived by the viewer of the image of the self-pixels (F2 in FIG. 4).

In the present embodiment, the judging section 3b compares the luminance of the self-pixels with that of the another-pixels, and judges that the cross talk of the image of the another-pixels is perceived by the viewer watching the image of the self-pixels in a case that luminance of the another-pixel exceeds the predetermined luminance. Judgment result is outputted to the adjustment means 4.

The “predetermined luminance” herein refers to a limit of luminance of the another-pixels at which cross talk of the image of the another-pixels is still not perceived by the viewer of the image of the self-pixels.

In the above, whether the cross talk is perceived by the viewer is judged by computing and comparing luminance of pixels adjacent to each other, yet the present invention is not limited to this. Alternatively, whether the cross talk of the image of the another-pixels is perceived by the viewer of the image of the self-pixels may be judged by computing the luminance of the another-pixels solely, and subsequently comparing it with luminance set in advance.

Next, the adjustment means 4 receives the judgment result from the distinction means 3, and adjusts the image signals (voltage) supplied to the scanning signal lines and the data signal lines provided to the another-pixels of the liquid crystal layer 14 of the display section 10 so as to eliminate the cross talk, in a case that the judgment result is that the cross talk of the another-image occurs to the self-image (F3 in FIG. 4).

Next, adjusting operation of the adjustment means 4 (FS in FIG. 4) will be described.

In the present embodiment, the adjustment means 4 eliminates the cross talk by adjusting luminance of the another-pixel once the judgment result that the cross talk of the another-image is perceived by the viewer of the self-image is inputted from the distinction means 3 to the adjustment means 4. Adjusting of the luminance is achieved by adjusting the image signals to the luminance set in advance. Specifically, it is preferable to reduce the luminance of the another-pixels to ¼ of the original luminance. As a result, the cross talk above is surely avoided. However, the present invention is not limited to this. The present invention may be configured such that while the image signals (voltage) are adjusted by the adjustment means 4, the distinction means 3 judges over time whether the cross talk is perceived, and the adjustment is continually performed until the cross talk is resolved.

Accordingly, it can be avoided that the cross talk of the another-image is perceived by the viewer of the image of the self-image.

As described above, the display device 1a of the present embodiment includes: the displaying section 10 in which a plurality of pixels for displaying images in predetermined directions are aligned in certain orders for the respective display directions of images; the image generating section 2 for generating the image signals of the images displayed on the pixels; the parallax barrier aperture array 17 for blocking light beams emitted from the pixels so that the light beams are not watched from directions other than the display directions of the pixels; the distinction means 3 for judging whether the cross talk of the image of the another-pixels reaches a level at which the cross talk is perceived by the viewer of the image of the self-pixels; and the adjustment means 4 for adjusting the pixel signals of the another-pixels so as to eliminate the cross talk once the distinction means 3 judges that the cross talk reaches the level at which the cross talk is perceived.

Accordingly, when the display device 1a displays different images to a plurality of display directions respectively, particularly when it displays images of the self-pixels and the another-pixels having significantly different characteristics, it is possible to eliminate the cross talk by the distinction means 3 judging whether or not the cross talk of the image of the another-pixels reaches the level at which the cross talk of the image of the another-pixels is perceived by the viewer of the image of the self-pixels; and further by the adjustment means 4 adjusting the image signals provided to another-pixels according to the judgment result so that the luminance of the another-pixels is changed to the predetermined luminance. Thus, according to the configuration above, excellent display environments can be offered in each display direction, while the cross talk of the images displayed in other display direction is not perceived by the viewer of the image displayed in a particular display direction.

Also, as described above, the display device 1a can be used for a vehicle; therefore, in a case that black image is displayed to the driver seat side (no image is displayed thereto) while the image is displayed to the front passenger seat side solely during the vehicle is being driven, the image displayed to the front passenger seat side (the cross talk image) is still not displayed on the black display for the driver seat side since the distinction means 3 and the adjustment means 4 are provided. Accordingly, even in a case, for example, that image of entertainment information or the like is displayed to the front seat side, that image will not be perceived from the driver seat side; therefore, a situation in which the driver's attention is distracted from driving can be avoided.

Also, the display device 1a of the present embodiment is configured such that the distinction means 3 includes: the luminance measuring section 3a measuring each luminance of the self-pixels and the another-pixels through the digitalization of distinction means 3 digitalizing image signals, the image signals being generated by the image generating section 2 and provided to the self-pixels and the another-pixels; and the judging section 3b judging that the luminance reaches a level at which the cross talk is perceived by the viewer of the image of the self-pixels, once the luminance of the another-pixels is judged to exceed the predetermined luminance by comparing each luminance of the self-pixels with that of the another-pixels. Therefore, based on the luminance known to be influential over the generation of the cross talk, the display device 1a of the present embodiment performs a proper adjustment such that the cross talk of the image of the another-pixels will not be perceived by the viewer of the image of the self-pixels.

Furthermore, the display device 1a of the present embodiment is configured such that the adjustment means 3 perform adjustment so as to reduce the luminance of the another-pixels to ¼ of the original luminance. With this configuration, the risk that the viewer of the images of the self-pixels perceives the cross talk of the image of the another-pixels can be surely avoided, and the good display environments are provided.

A display device of the present invention is not limited to the configuration that eliminates the cross talk by adjusting the luminance of the another-pixels. Alternatively, the present invention may be configured such that once the adjustment means 3 judges that the cross talk of the images of the another-pixels reaches a level at which such cross talk is perceived by the viewer of the image of the self-pixels (F2 in FIG. 4), the adjustment means 4 adjusts the image signals from the image generating section 2 such that an image displayed by the another-pixels is identical with an image displayed by the self-pixels. Accordingly, the cross talk can be avoided.

However, with respect to the configuration in which identical images are displayed, in a case that the image for the front passenger seat side (in this case, self-pixels) is displayed to the driver seat side (in this case, another-pixels), displaying such image as entertainment program or the like, which distracts the driver's attention, will cause a safety hazard or a legal issue. Thus, in a situation where identical images are displayed, the display device is preferably configured such that an image for the front passenger seat side is not displayed to the driver seat side if the image is judged to be of the above image information (so called fail safe processing).

As yet another configuration, a display device of the present invention may be configured such that once the adjustment means 3 judges that the cross talk of the image of the another-pixels reaches a level at which such cross talk is perceived by the viewer of the image of the self-pixels (F2 in FIG. 4), the adjustment means 4 adjusts so as to cause the another-pixels to display a black image (all black image, nothing displayed). Consequently, the cross talk can be surely avoided. In this case, the cross talk of the image of the another-pixels is not perceived on the driver seat side (self-pixels) at all, so the condition that may distracts the driver's attention from driving can be avoided.

### Embodiment 2

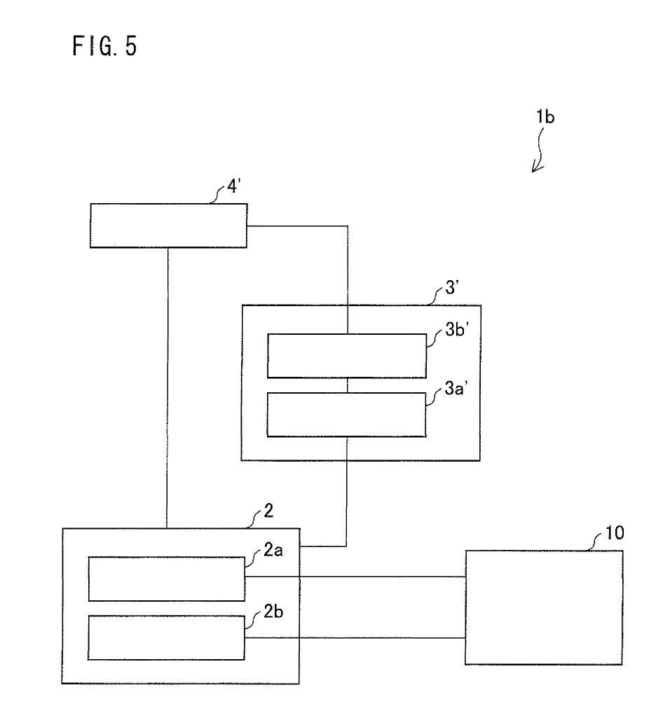

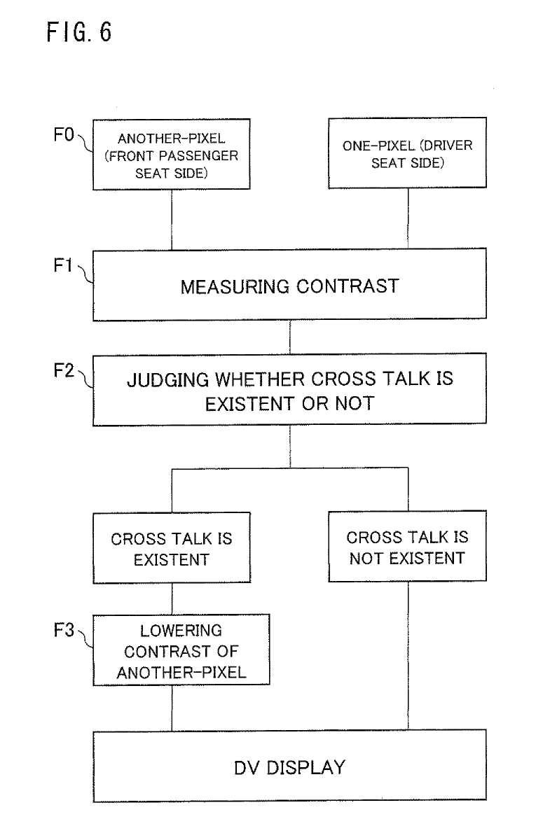

Another embodiment of the present invention will be described as below with reference to FIGS. 5 and 6. In the present embodiment, differences from Embodiment 1 are described; therefore, as a matter of convenience of explanation, members having the same functions as those described in Embodiment 1 are given the same reference numerals in the present embodiment, and explanations thereof are omitted here.

FIG. 5 is a diagram showing a configuration of a display device 1b of the preset embodiment. The display device 1b illustrated in FIG. 5 includes distinction means 3′ that uses contrasts of the self-pixels (first image) and the another-pixels (second image) as information for making judgment on cross talk, while the display device 1 described in Embodiment 1 includes the distinction means 3 that uses luminance of the self-pixels (first image) and the another-pixels (second image) as information for making judgment on cross talk. In addition, the display device 1b of the present embodiment includes adjustment means 4′ adjusting the contrast of the another-pixels, while the display device 1 descried in Embodiment 1 includes the adjustment means 4 adjusting the luminance of the another-pixels. Operations of the display device 1b of the present embodiment will be described below with reference to FIG. 6.

FIG. 6 is a flowchart for explaining operations of the display device 1b of the present embodiment. As illustrated in FIG. 6, in the display device 1b of the present embodiment, image signals are first provided from an image generating section 2 to the scanning signal lines and the data signal lines of the liquid crystal layer 14 of a display section 10 (F0 in FIG. 6), then at substantially the same time, the distinction means 3′ acquires the image signals of the self-pixels and the another-pixels, and judges whether the cross talk of the image of the another-pixels reaches a level at which the cross talk is perceived by the viewer of the image of the self-pixels (F1 in FIG. 6).

The distinction means 3′ includes a contrast measuring section 3a′ measuring contrasts of the self-pixels and the another-pixels; and a judging section 3b′ judging that the cross talk of the image of the another-pixels is perceived by the viewer of the image of the self-pixels once the luminance of the another-pixels exceeds a predetermined contrast value. Contrast is a cause of cross talk between pixels adjacent to each other. Thus, whether the cross talk reaches a level at which it is perceived can be judged by comparing each contrast of the self-pixels and the another-pixels at the judging section 3b′.

At first, the contrast measuring section 3a′ acquires the image signals provided by the image generating section 2, and digitalizes them so as to compute the contrasts of the self-pixels and the another-pixels (F1 in FIG. 6). Digitalization is performed by, for example, calculating luminance in RGB to digital values of pixel luminance (0 to 255), setting an in-plane luminance difference threshold (for example, 50:1), and judging the contrast as a high contrast if there is any value greater than or equal to the threshold. Then, at the judging section 3b′, whether the cross talk of the image of the another-pixels reaches a level at which the cross talk is perceived by the viewer of the image of the self-pixels is judged by comparing contrasts of the self-pixels and the another-pixels (F2 in FIG. 6).

In the present embodiment, the judging section 3b′ compares the contrasts of the self-pixels and the another-pixels, and if the luminance of the another-pixels exceeds the predetermined contrast value, it is judged that the cross talk of the image of the another-pixels occurs to the self-pixels. The judgment result is outputted to the adjustment means 4′.

Here, the “predetermined contrast value” is a limit of a contrast value of the image of the another-pixels at which cross talk of the image of the another-pixels still does not occur to the image of the self-pixels.

Next, adjusting operations of the adjustment means 4′ of the present embodiment will be described (F3 in FIG. 6).

In the present embodiment, the adjustment means 4′ adjusts the luminance of the another-pixels once it receive the judgment result from the distinction means 3′ that the cross talk reaches a level at which the cross talk is perceived by the viewer. Specifically, the adjustment means 4′ adjusts the image signals of the another-pixels so that the contrast thereof is changed to the contrast value set in advance. This lowers the contrast. However, the present invention is not limited to this configuration. Alternatively, the present invention can be configured such that cross talk is eliminated through the process that the distinction means 3′ judges over time whether the cross talk reaches a level at which the cross talk is perceived by the viewer while the adjustment means 4′ is adjusting the image signals (voltage).

This makes it possible to avoid that the viewer of the image of the self-pixels perceives the cross talk of the image of the another-pixels.

As described above, by including the distinction means 3′ and the adjustment means 4′, the display device 1b of the present embodiment provides excellent display environments to each display direction in a situation where it displays different images in a plurality of display directions respectively, the excellent display environment where cross talk of an image displayed in another display direction (another-pixels) is not perceived by the viewer of an image of image (self-pixels) displayed to a particular display direction. Particularly, according to the configuration above, the display device 1b providing the good display environments where the cross talk is not perceived is achieved by adjusting the contrast known to be influential over generation of the cross talk.

As in the case of Embodiment 1, the display device 1b of the present embodiment may be configured such that the cross talk is eliminated by adjusting the luminance of the another-pixels. Alternatively, the display device 1b of the present embodiment can be configured such that once the adjustment means 3′ judges that the cross talk of the image of the another-pixels reaches a level at which the cross talk is perceived by the viewer of the image of the self-pixels, the adjustment means 4′ adjusts the image signals so that an image of the another-pixels is identical with an image of self-pixels. As yet another configuration, the display device 1b of the present embodiment may be configured such that once the adjustment means 3′ judges that the cross talk of the image of the another-pixels reaches a level at which the cross talk is perceived by the viewer of the image of the self-pixels, the adjustment means 4, adjusts the image signals so that the another-pixels display a black image (displays nothing).

### Embodiment 3

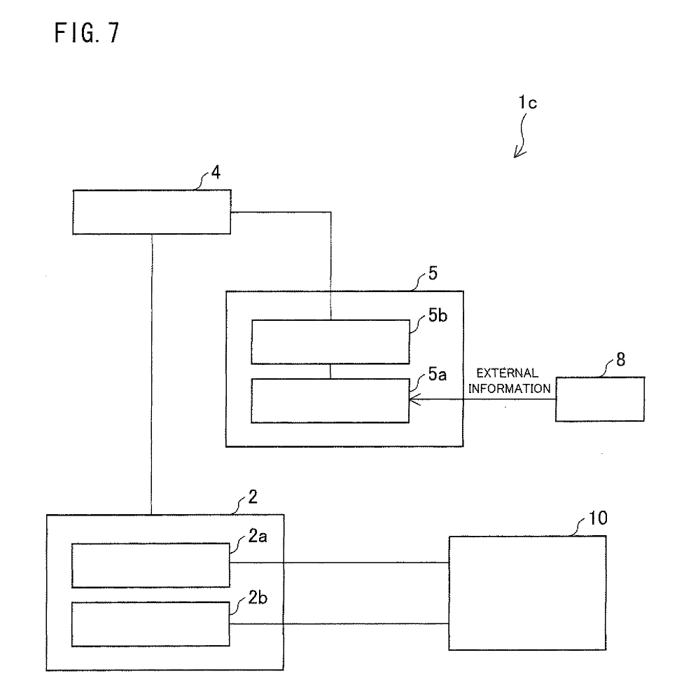

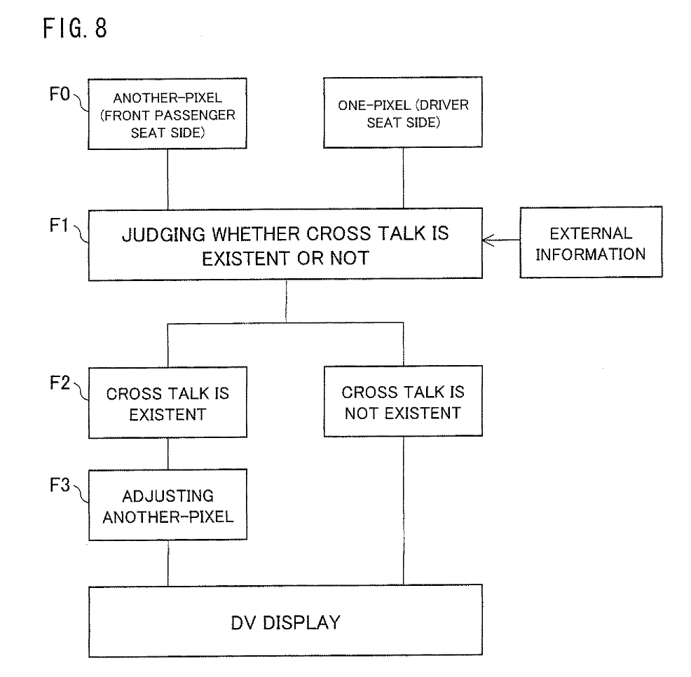

Yet another embodiment of the present invention will be described as below with reference to the FIGS. 7 and 8. In the present embodiment, differences from Embodiment 1 are described; therefore, as a matter of convenience of explanation, members having the same functions as those described in Embodiment 1 are given the same reference numerals in the present embodiment, and explanations thereof are omitted here.

FIG. 7 is a block diagram showing a configuration of a display device 1c of the present embodiment. The display device 1c illustrated in FIG. 7 includes distinction means 5 having an external information acquiring section (information signal generating section) 5a and a judging section 5b, instead of the distinction means 3 of the display device 1 described in Embodiment 1. Furthermore, the display device 1c of the present embodiment includes a clock time information outputting section 8 capable of outputting clock time information (external information). The display device 1c of the present embodiment will be described below with reference to FIG. 7.

The distinction means 5 is connected to the adjustment means 4. The external information acquiring section 5a is connected to the clock time information outputting section 8.

Cross talk is more likely to be seen if the display device is viewed under a dark environment such as nighttime, as compared to a bright condition such as daytime. Thus, the display device 1c of the present embodiment, by having the external information acquiring section 5a, judges based on clock time information whether the environment under which the display device is viewed is dark, in other words, whether the environment under which the display device is viewed is a condition in which the cross talk is more likely to be seen.

A configuration and operations of the display device 1c of the present embodiment will be described below with reference to FIG. 8.

FIG. 8 is a flowchart for explaining operations of the display device 1c of the present embodiment. As illustrated in FIG. 8, at substantially the same time as the image signals are first provided from the image generating section 2 to the scanning signal lines and data signal lines of the liquid crystal layer 14 of the display section 10 (F0 in FIG. 8), the distinction means 5 acquires the image signals of the self-pixels and the another-pixels. In addition, the external information acquiring section 5a of the distinction means 5 acquires clock time information from the clock time information outputting section 8 (F1 in FIG. 8). Once the external information acquiring section 5a acquires the clock time information, it generates external information signals, and outputs them to the judgment section 5b.

The judging section 5b judges whether it is under circumstances where the cross talk is more likely to be perceived, in accordance with the external information signals. If it judges that it is under circumstances where the cross talk is more likely to be perceived (F2 in FIG. 8), the judging section 5b outputs the judgment result to the adjustment means 4.

Upon receipt of the judgment result from the judging section 5b, the adjustment means 4 adjusts the image signals of the another-pixels (F3 in FIG. 8) so that the viewer of the image of the self-pixels does not perceive the cross talk of the image of the another-pixels. Adjusting of the image signals by the adjustment means 4 can be performed in the same way as described in Embodiments 1 and 2 above.

Consequently, in a case that different images are displayed in a plurality of display directions respectively, cross talk of an image displayed to a particular display direction does not occur to an image displayed to another display direction, and thus, excellent display environments can be provided to each display direction.

In the present embodiment, the display device 1c is configured such that it includes the clock time information outputting section, yet the present invention is not limited to this. Alternatively, the external information acquiring section 5a may acquires clock time information from a clock commonly mounted in a vehicle equipped with the display device 1c, and connected to the distinction means 5.

Furthermore, the display device 1c of the present embodiment may be such that it acquires external information from headlights mounted in a vehicle.

Headlights are used when a vehicle runs at nighttime or through a tunnel. That is, if the headlights are turned on, it follows that an environment under which the display device is viewed is darker, as compared to a bright environment such as daytime, and cross talk of image of the another-pixels is more likely to be perceived by the viewer of the image of the self-pixels. Therefore, the display device of the present invention can be configured such that the headlight are connected to the external information acquiring section 5, so that the display device recognizes that the images are displayed in an environment where the cross talk is more likely to be perceived, once the external information acquiring section 5a acquires the fact that the headlights have been turned on (external information).

### Embodiment 4

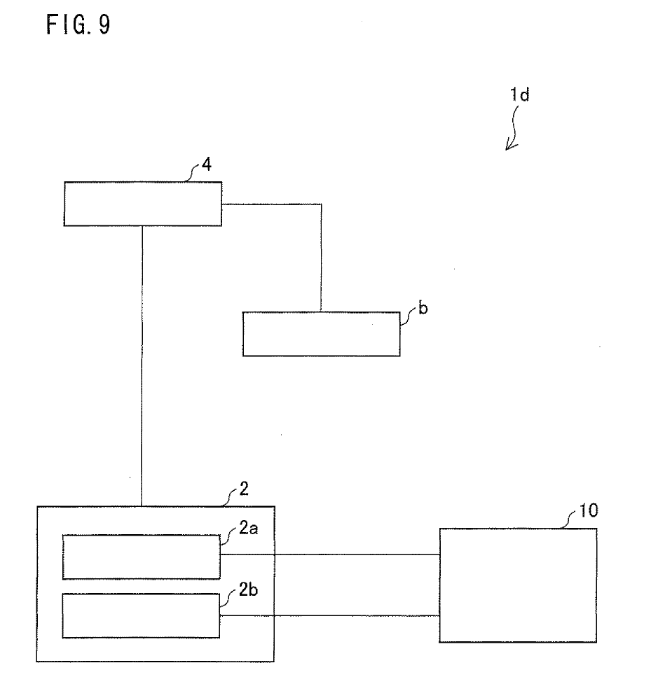

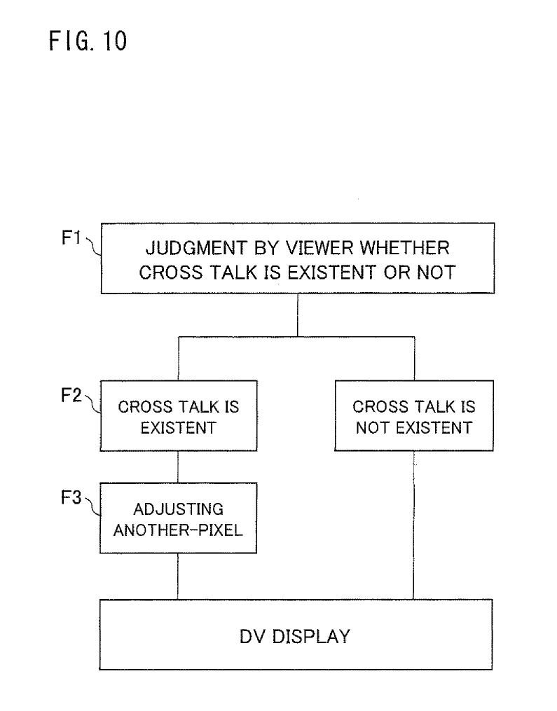

Yet another embodiment of the present invention will be described as below with reference to FIGS. 9 and 10. In the present embodiment, differences from Embodiment 1 are described; therefore, as a matter of convenience of explanation, members having the same functions as those described in Embodiment 1 are given the same reference numerals in the present embodiment, and explanations thereof are omitted here.

FIG. 9 is a block diagram showing a configuration of a display device 1d of the present embodiment. The display device 1d illustrated in FIG. 9 includes input means (information signal generating section) 6, instead of the distinction means 3 of the display device 1 described in Embodiment 1. The display device 1d including the input means 6 will be described below with reference to FIG. 9.

The input means 6 of the display device 1d of the present embodiment is, as illustrated in FIG. 9, connected to adjustment means 4. In the display device 1d of the present embodiment, the viewer of the display device 1d (display section 10) judges whether the self-pixels (first pixels) display a superimposed image, in other words, whether the image of the self-pixels (first pixels) becomes a cross talk image due to the image of the another-pixels. If the viewer perceives the cross talk and wants to eliminate it, he/she operates the input means 6. The input means 6 is configured so as to output inputted information to the adjustment means 4, so that the adjustment means 4 eliminates the cross talk.

That is, the display device 1d of the present embodiment is configured such that when the cross talk is perceived by the viewer, it is eliminated by the viewer's inputs.

Operations of the display device 1d of the present embodiment will be described with reference to FIG. 10. FIG. 10 is a flowchart explaining the operations of the display device 1d of the present embodiment. As illustrated in FIG. 10, in the display device 1d of the present embodiment, the image signals are first provided from the image generating section 2 to the scanning signal lines and the data signal lines of the liquid crystal layer 14 of the display section 10, and the viewer (the driver) on the driver seat side watches an image of the self-pixels (first image) displayed to the direction of the driver seat side. The driver observes the image of the self-pixels, and judges whether it becomes the superimposed images (F1 in FIG. 10).

In a case that the self-pixels display the superimposed image, it follows that cross talk of the image displayed in the direction of the front passenger seat side (second image) occurs. Therefore, if the driver perceives the superimposed image, he/she operates the input means 6 to request the adjustment means 4 for cross-talk eliminating operation.

Specifically, the input means 6 includes a switching function and is configured so as to provide the adjustment means 4 with the information inputted from the viewer. However, the present invention is not limited to this, and the input means 6 may include a button function or the like.

The adjustment means 4 is connected to the input means 6, and once it receives the input result from the input means 6, the adjustment means 4 adjusts the image signals of the another-pixels so that the cross talk is not perceived (F3 in FIG. 10).

Adjusting of the image signals can be performed in the same way as described in Embodiments 1 and 2 above.

Consequently, in a case that different images are displayed in a plurality of display directions respectively, the viewer of an image displayed in a particular display direction does not perceive the cross talk of images displayed in another direction, thus excellent display environments can be provided in each display direction. Furthermore, as compared to Embodiments 1 and 2 described above, the display device of the present invention is configured such that the adjustments are not performed as long as the viewer does not perceive the cross talk, even if the generation of cross talk is detected at the time of contrast measurement or luminance measurement. As a result, power consumption resulting from the adjusting operations by the adjustment means 4 can be reduced.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

A display device and a vehicle of the present invention, which displays different images to a plurality of display directions respectively, are capable of providing excellent display environments in each display direction while a viewer of an image displayed in a particular display direction does not perceive cross talk of an images displayed in other display direction.

As a result, the present invention is suitable for display devices that include DV (dual view) display devices for vehicle use, which display different images toward the driver seat side and the front passenger (fellow passenger) seat side. The DV display devices are not limited for vehicle use, and they can be widely used for, for example, dual screen televisions, match-up video games, and street advertisements.

1. A display device that displays different images in a plurality of display directions respectively, comprising:
displaying means in which a plurality of pixels for displaying the images in predetermined directions are aligned in certain orders for the respective display directions of the images;
an image generating section for generating image signals of the images displayed on the pixels; and
light shield means for blocking light beams emitted from the pixels so that the light beams are not watched from any directions other than the display directions of the pixels,
the display device comprising:
distinction means for judging whether cross talk of an image group b displayed in a direction other than a particular direction in which a viewer watches an image a displayed reaches a level at which the cross talk of the image group b is perceived by the viewer; and
adjustment means for adjusting the image signals of the image group b to eliminate the cross talk, once the distinction means judges that the cross talk reaches the level at which the cross talk is perceived by the viewer.

2. The display device as set forth in claim 1, wherein the image a is a first image displayed in a first direction and the image group b is a second image displayed in a second direction different from the first direction.

3. The display device as set forth in claim 2, wherein the distinction means comprises: a luminance measuring section for measuring each luminance of the first image and the second image by digitalizing each image signal of the first image and the second image; and a judging section for judging that the cross talk reaches the level at which the cross talk is perceived by the viewer, in a case that luminance of the second image exceeds a predetermined luminance.

4. The display device as set forth in claim 2, wherein the distinction means comprises: a contrast measuring section for measuring each contrasts of the first image and the second image by digitalizing each image signal of the first image and the second image; and a judging section for judging that the cross talk reaches the level at which the cross talk is perceived by the viewer, in a case that contrast of the second image exceeds a predetermined contrast.

5. The display device as set forth in claim 2, wherein the distinction means comprises: an information signal generating section for generating an external information signal in accordance with external information different from the image signals; and a judging section for judging that the cross talk reaches the level at which the cross talk is perceived by the viewer, in accordance with the external information signals.

6. The display device as set forth in claim 3, wherein the adjustment means is configured so as to lower luminance of the second image, in accordance with a judgment result by the judging section.

7. The display device as set forth in claim 4, wherein the adjustment means is configured so as to lower the contrast of the second image, in accordance with a judging result by the judging section.

8. The display device as set forth in claim 5, wherein the adjustment means is configured so as to make pixels for displaying the second image display the first image, in accordance with a judgment result by the judging section.

9. The display device as set forth in claim 3, wherein the adjustment means is configured so as to make the second image undisplayed, in accordance with a judgment result by the judging section.

10. The display device as set forth in claim 4, wherein the adjustment means is configured so as to lower the luminance of the second image to ¼ of original luminance.

11. The display device as set forth in claim 5, further comprising a clock time information outputting section capable of outputting clock time information, wherein the external information is the clock time information.

12. The display device as set forth in claim 3, wherein the external information is viewing information of the viewer of the first image.

13. The display device as set forth in claim 4, wherein the adjustment means is configured so as to make pixels for displaying the second image display the first image, in accordance with a judgment result by the judging section.

14. The display device as set forth in claim 5, wherein the adjustment means is configured so as to make pixels for displaying the second image display the first image, in accordance with a judgment result by the judging section.

15. The display device as set forth in claim 3, wherein the adjustment means is configured so as to make the second image undisplayed, in accordance with a judgment result by the judging section.

16. The display device as set forth in claim 4, wherein the adjustment means is configured so as to make the second image undisplayed, in accordance with a judgment result by the judging section.

17. The display device as set forth in claim 5, wherein the adjustment means is configured so as to make the second image undisplayed, in accordance with a judgment result by the judging section.

18. The display device as set forth in claim 6, wherein the adjustment means is configured so as to lower the luminance of the second image to ¼ of original luminance.

19. The display device as set forth in claim 7, wherein the adjustment means is configured so as to lower the luminance of the second image to ¼ of original luminance.

20. The display device as set forth in claim 8, wherein the adjustment means is configured so as to lower the luminance of the second image to ¼ of original luminance.

21. The display device as set forth in claim 5, further comprising a clock time information outputting section capable of outputting clock time information, wherein the external information is the clock time information.

22. The display device as set forth in claim 5, wherein the external information is viewing information of the viewer of the first image.
